(19) United States
(12) Patent Application Publication
(10) Pub. No.: US 2010/0214611 A1
(43) Pub. Date: Aug. 26, 2010

(54) IMAGE PROCESSING APPARATUS, CONTROL METHOD THEREFOR, AND STORAGE MEDIUM STORING CONTROL PROGRAM THEREFOR

(75) Inventor: Akinori Watanabe, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/711,693

(22) Filed: Feb. 24, 2010

(30) Foreign Application Priority Data
Feb. 24, 2009 (JP) 2009-040886

(51) Int. Cl. G06F 15/00

(52) U.S. Cl. 358/1.15

(57) ABSTRACT

An image processing apparatus that is capable of executing a process efficiently by reducing a time required for the connection process to a host apparatus that has a high communication frequency among a plurality of host apparatuses connected by the WUSB communication. A generation unit generates connection history information based on information received from a plurality of host apparatuses connected. A detection unit detects a condition in which none of the plurality of host apparatuses is connected. A control unit selects a host apparatus of the highest communication frequency among the plurality of host apparatuses based on the connection history information when the detection unit detects the condition in which none of the plurality of host apparatuses is connected, and to perform a connection process to the selected host apparatus.

### BACKGROUND OF THE INVENTION

1. Field of the Invention

The present invention relates to an image processing apparatus that is connected to a plurality of host PCs by wireless communication, a control method therefor, and a storage medium storing a control program therefor.

2. Description of the Related Art

A standard of wireless USB (referred to as WUSB, hereafter), which is a wireless version of a USB interface that is one of the most frequently used and popular standards to connect a peripheral device to a computer, has been drawn up.

An outline of establishment of one-to-one connection by WUSB communication between a host apparatus (a PC, for example) and a device (a multifunction printer (MET), for example) will be described with reference to FIG. 9.

In FIG. 9, the host apparatus 10 is equipped with a WUSB host antenna 11, and the device 20 is equipped with a WUSB device antenna 21. The connection establishment procedure of the WUSB based on a security policy is roughly divided into an identification phase, an authentication phase, and a permission phase.

In the identification phase, the device 20 detects the host apparatus 10, and transmits a connection request to the host apparatus 10. In the authentication phase, mutual recognitions are established between the host apparatus 10 and the device 20. In the permission phase, information interchange by secure communication is allowed. When a secure connection is established, the host apparatus 10 communicates with the device 20 while enciphering data.

Specifically, when an application of the host apparatus 10 generates a print job and transmits a print request to the device 20, the host apparatus 10 transmits beacons that include a unique ID of the device 20 from the WUSB host antenna 11 to the device 20 at constant intervals. It should be noted that host identification information (ID) and device identification information (ID) that are included in the beacon comprise a unique ID of the host apparatus 10 and a unique ID of the device 20, respectively.

When receiving the beacon as the print request via the WUSB device antenna 21, the device 20 starts a one-to-one connection process to establish communication.

First, the device 20 analyzes the device ID of the beacon received from the host apparatus 10, and checks whether or not the received device ID is its own device ID. If the device IDs are different, the device 20 determines that the beacon is not for itself, and abandons the beacon.

When the received device ID is its own device ID, the device 20 analyzes the host ID in the beacon, and checks whether or not the host ID of the beacon is identical to a host ID that has been registered into the device 20 by an association.

When the host ID of the beacon is not identical to the host ID that has been registered into the device 20 by the association, the device 20 determines that the host is not set by the association, and abandons the beacon.

It should be noted that some methods are prepared for the association. In an association process in WUSB security, in order to establish a secure connection by the host apparatus 10 and the device 20, information called CC (Connection Context) must be shared between the host apparatus 10 and the device 20. The CC comprises a unique host ID, a unique device ID, and information of a connection key shared between the host device 10 and the device 20.

On the other hand, the device 20 replies a connection request to the host apparatus 10, when the host ID of the beacon is identical to the host ID registered into the device 20 by the association.

If the host apparatus 10 permits a connection in response to the connection request and a mutual connection is established between the host apparatus 10 and the device 20, the information interchange by the secure communication is allowed.

Then, the host apparatus 10 transmits print data that has been spooled as encryption data to the device 20. When the data transmission is finished, the host apparatus terminates the communication by a disconnect request for connection to another host apparatus etc. It should be noted that the disconnect request can be required from both of the host apparatus 10 and the device 20.

However, in the above-mentioned WUSB communication, only one host apparatus 10 is connectable to one device 20 at once. Therefore, when the print request is received from the host apparatus 10, the device 20 is occupied by communication with this host apparatus 10, and cannot accept a print request from another host apparatus.

In order to solve such a problem, a system in which a device makes a list of pieces of host information from the beacons received from a plurality of host apparatuses and transmits a connection request to the host apparatuses based on an order of the list is proposed (see Japanese laid-open patent publication (Kokai) No. 2007-251851 (JP2007-251851A)).

In the system of the above-mentioned publication, since the device puts the host apparatuses in order and connects when one device is shared by a plurality of host apparatus by the wireless communication, it is possible to take advantage of the convenience of the wireless connection, but it takes time to execute the connection process by the device.

### SUMMARY OF THE INVENTION

The present invention provides a mechanism that is capable of executing a process efficiently by reducing a time required for an connection process to a host apparatus that has a high communication frequency among a plurality of host apparatuses connected by WUSB communication.

Accordingly, a first aspect of the present invention provides an image processing apparatus that is connected to a plurality of host apparatuses by wireless communication, comprising a generation unit adapted to generate connection history information based on information received from the host apparatuses, a detection unit adapted to detect a condition in which none of the plurality of host apparatuses is connected, and a control unit adapted to select a host apparatus of the highest communication frequency among the plurality of host apparatuses based on the connection history information when the detection unit detects the condition in which none of the plurality of host apparatuses is connected, and to perform a connection process to the selected host apparatus.

Accordingly, a second aspect of the present invention provides a control method for an image processing apparatus that is connected to a plurality of host apparatuses by wireless communication, the control method comprising a generation step of generating connection history information based on information received from the host apparatuses, a detection step of detecting a condition in which none of the plurality of host apparatuses is connected, and a control step of selecting a host apparatus of the highest communication frequency among the plurality of host apparatuses based on the connection history information when the condition in which none of the plurality of host apparatuses is connected is detected in the detection step, and of performing a connection process to the selected host apparatus.

Accordingly, a third aspect of the present invention provides a storage medium storing a control program causing a computer to execute a control method for an image processing apparatus that is connected to a plurality of host apparatuses by wireless communication, the control method comprising a generation step of generating connection history information based on information received from the host apparatuses, a detection step of detecting a condition in which none of the plurality of host apparatuses is connected, and a control step of selecting a host apparatus of the highest communication frequency among the plurality of host apparatuses based on the connection history information when the condition to be condition in which none of the plurality of host apparatuses is connected is detected in the detection step, and of performing a connection process to the selected host apparatus.

According to the present invention, since a time that is required for the connection process to the host apparatus that has a high communication frequency among the plurality of host apparatuses connected via the WUSB communication can be reduced, the image processing apparatus can execute the process efficiently.

Further features of the present invention will become apparent from the following description of exemplary embodiments with reference to the attached drawings.

### BRIEF DESCRIPTION OF THE DRAWINGS

FIG. 1 is a view showing a schematic configuration of a system in which an image processing apparatus according to a first embodiment of the present invention is connected to a plurality of host PCs by WUSB communication.

FIG. 2 is a block diagram schematically showing a configuration of one of the host PCs shown in FIG. 1.

FIG. 3 is a block diagram schematically showing a configuration of the image processing apparatus shown in

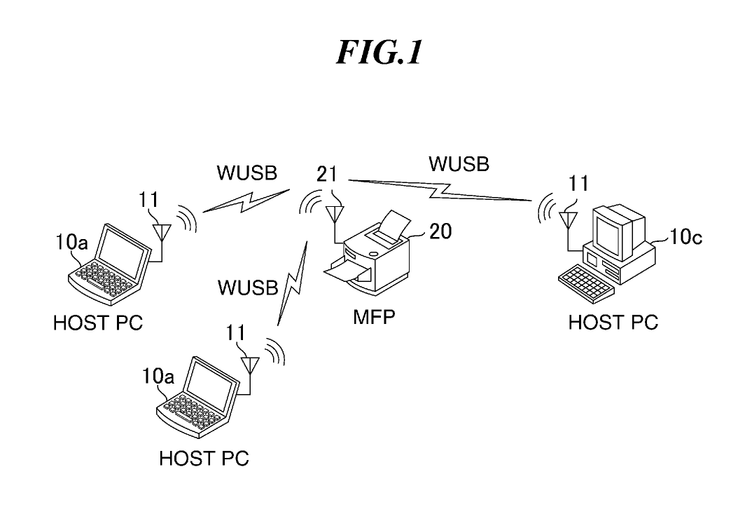

FIG. 1.

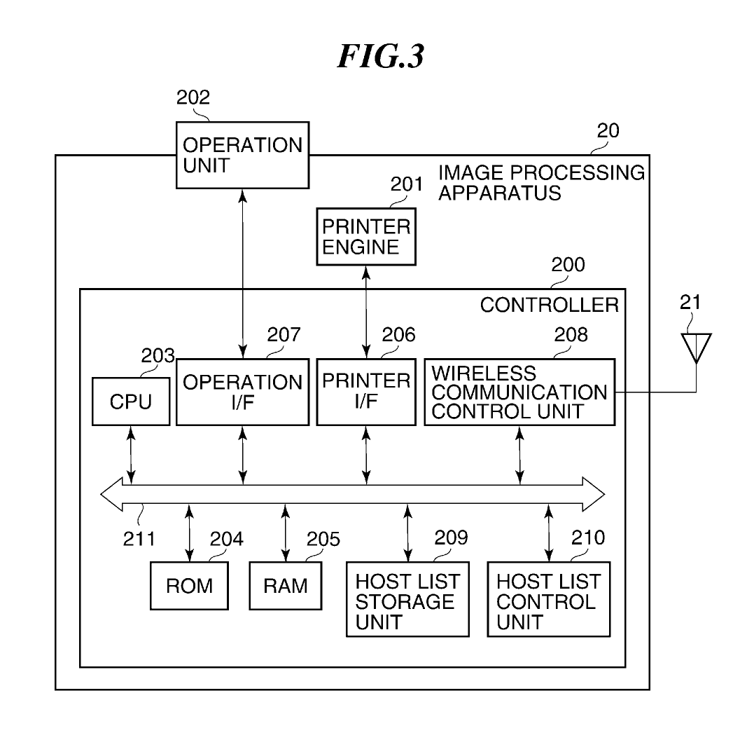

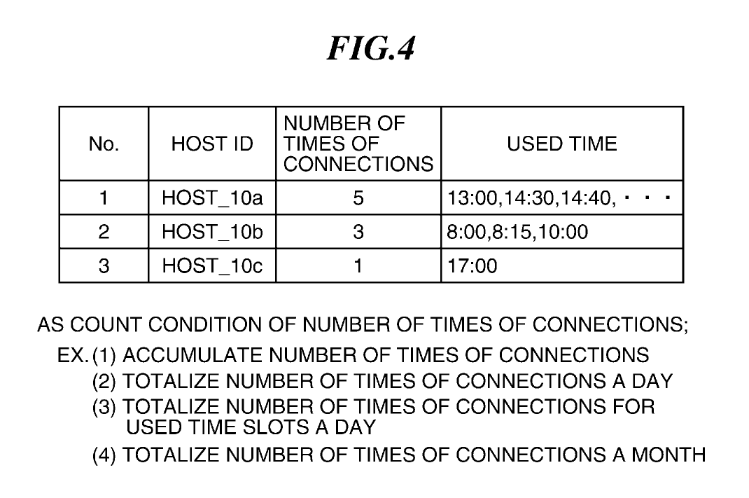

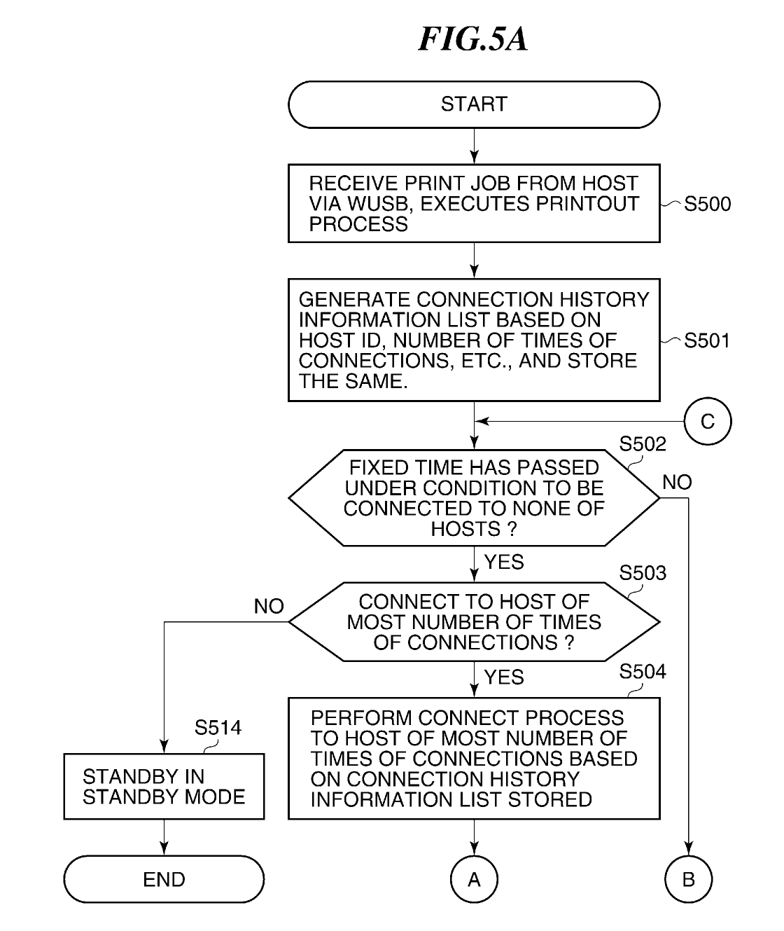

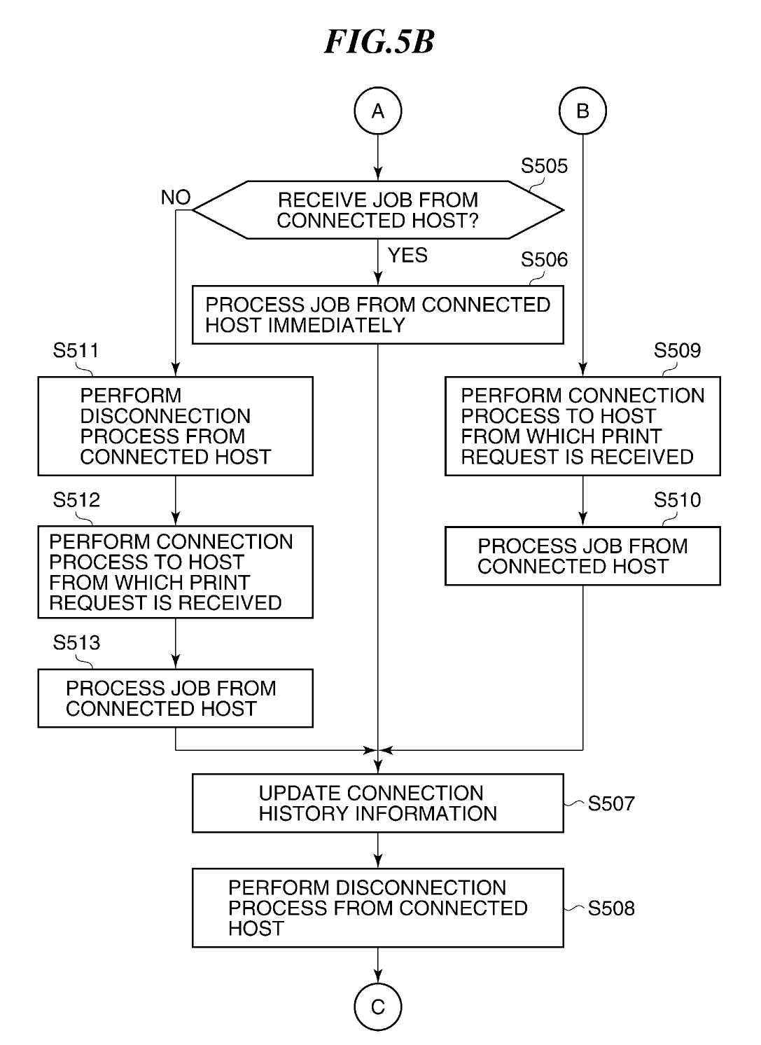

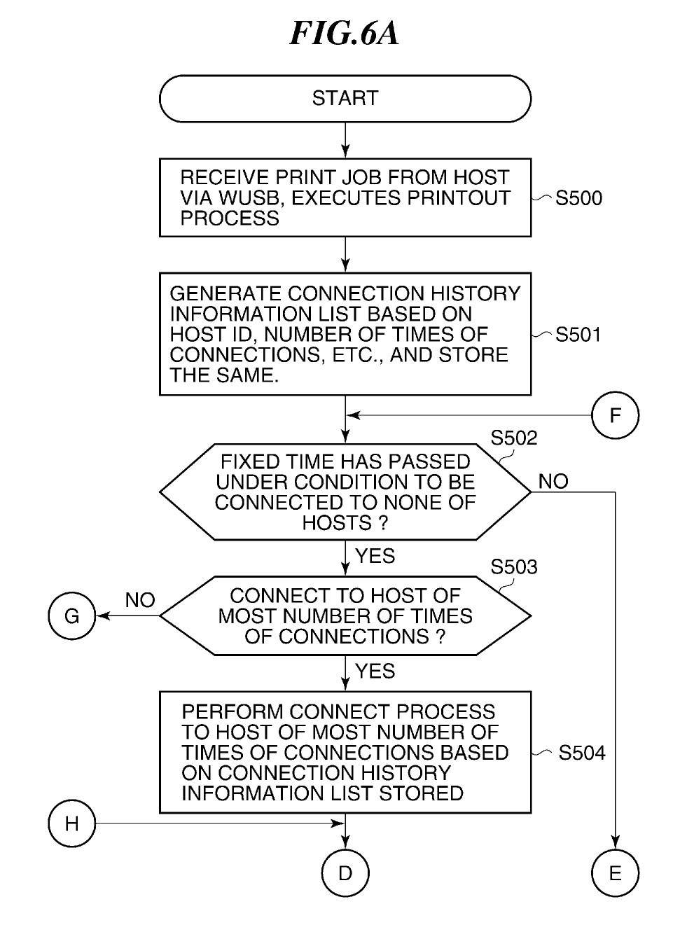

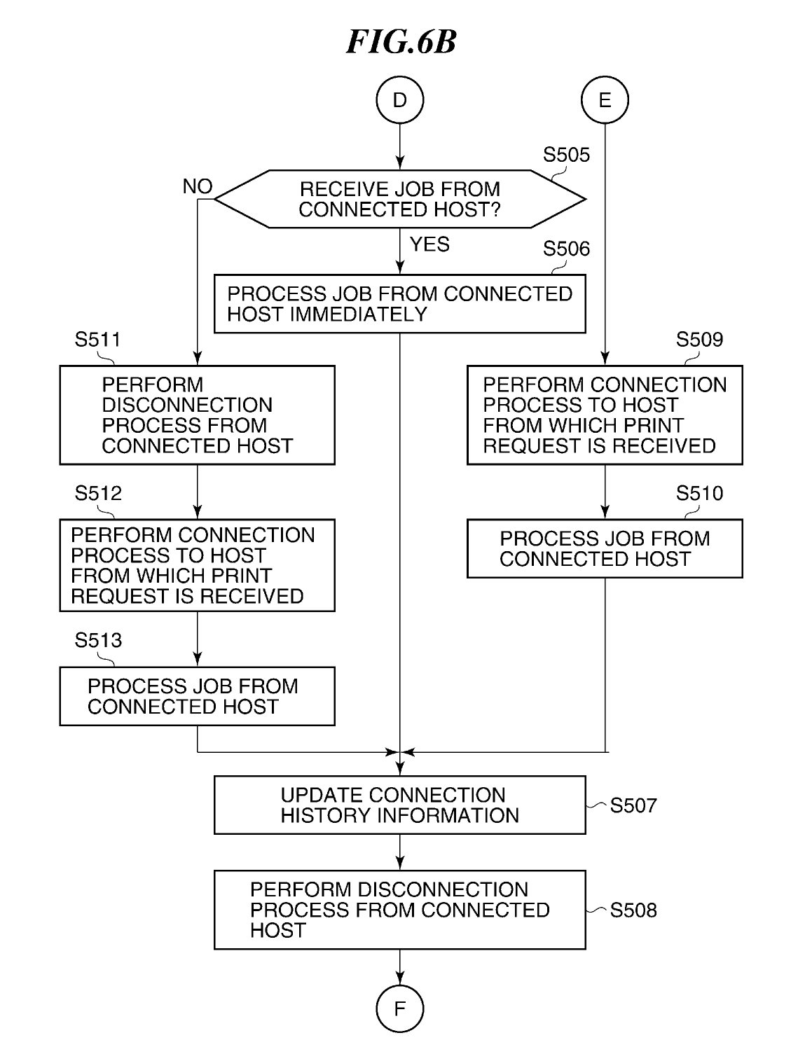

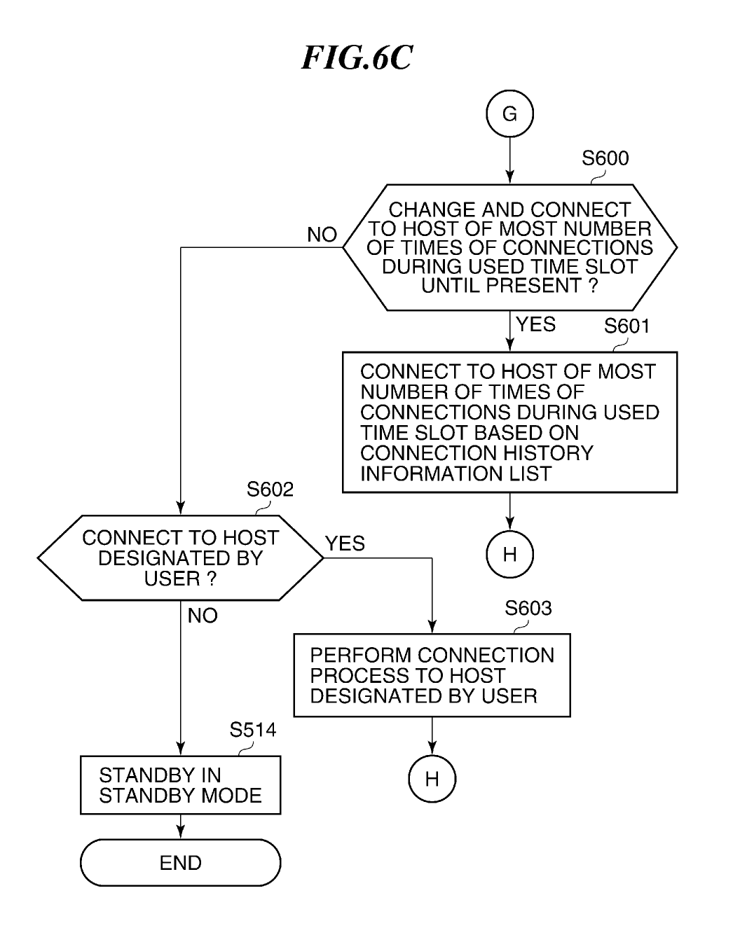

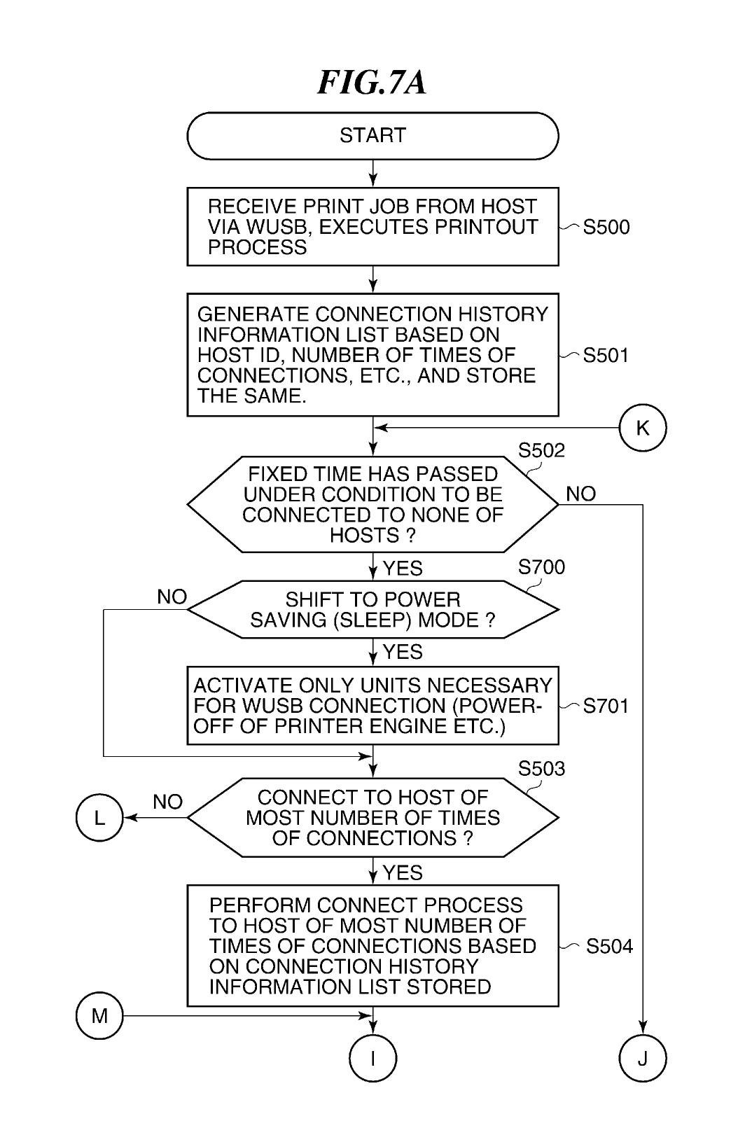

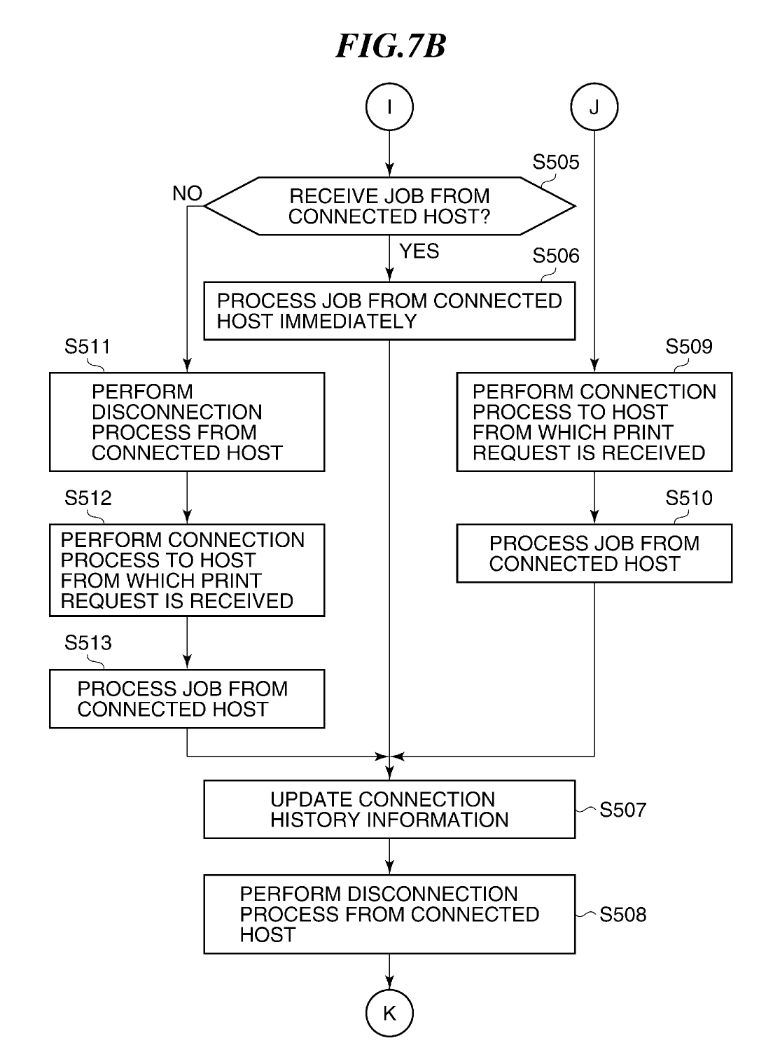

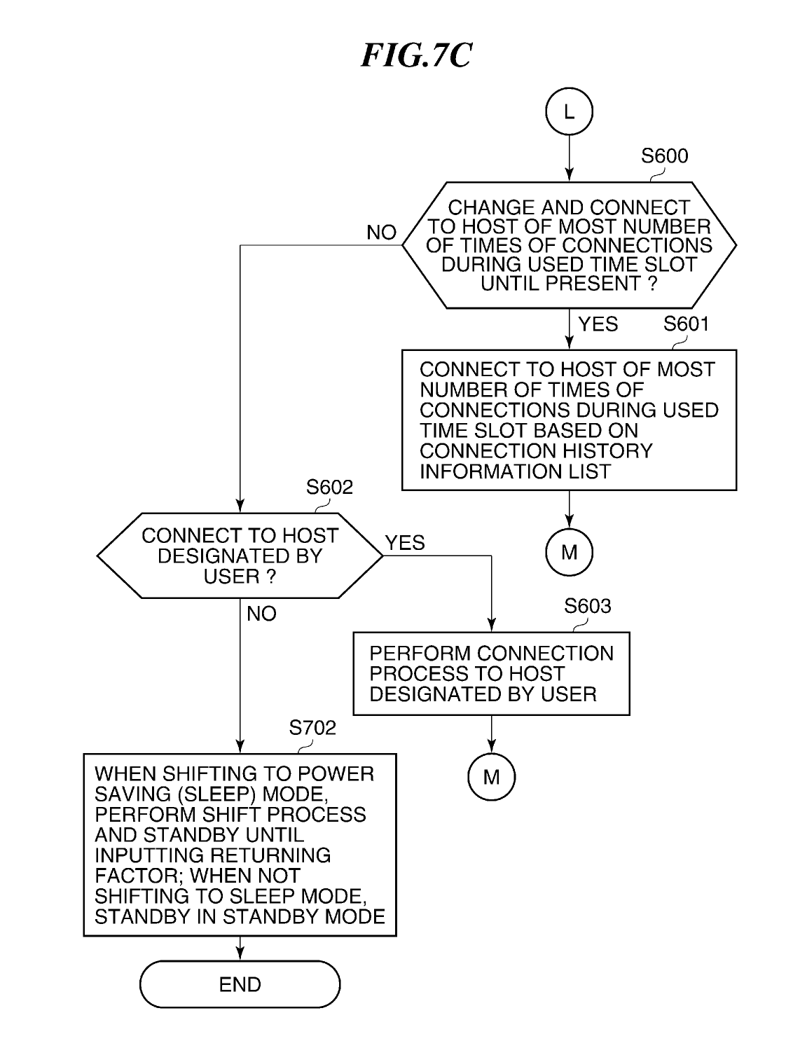

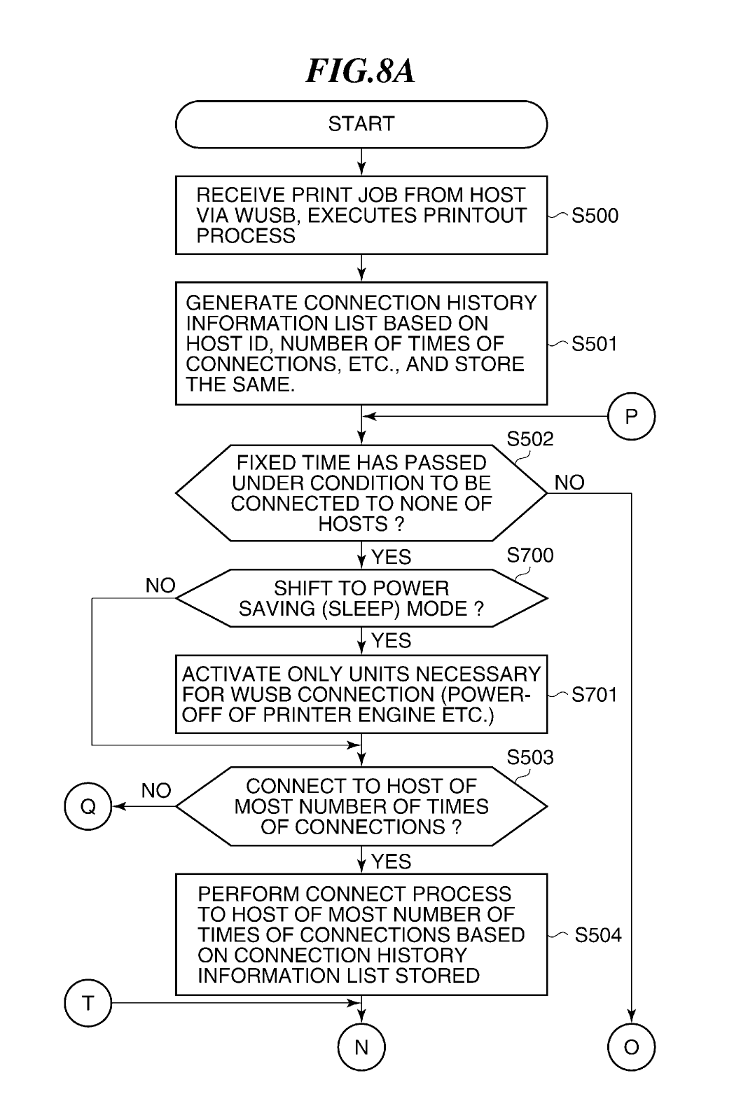

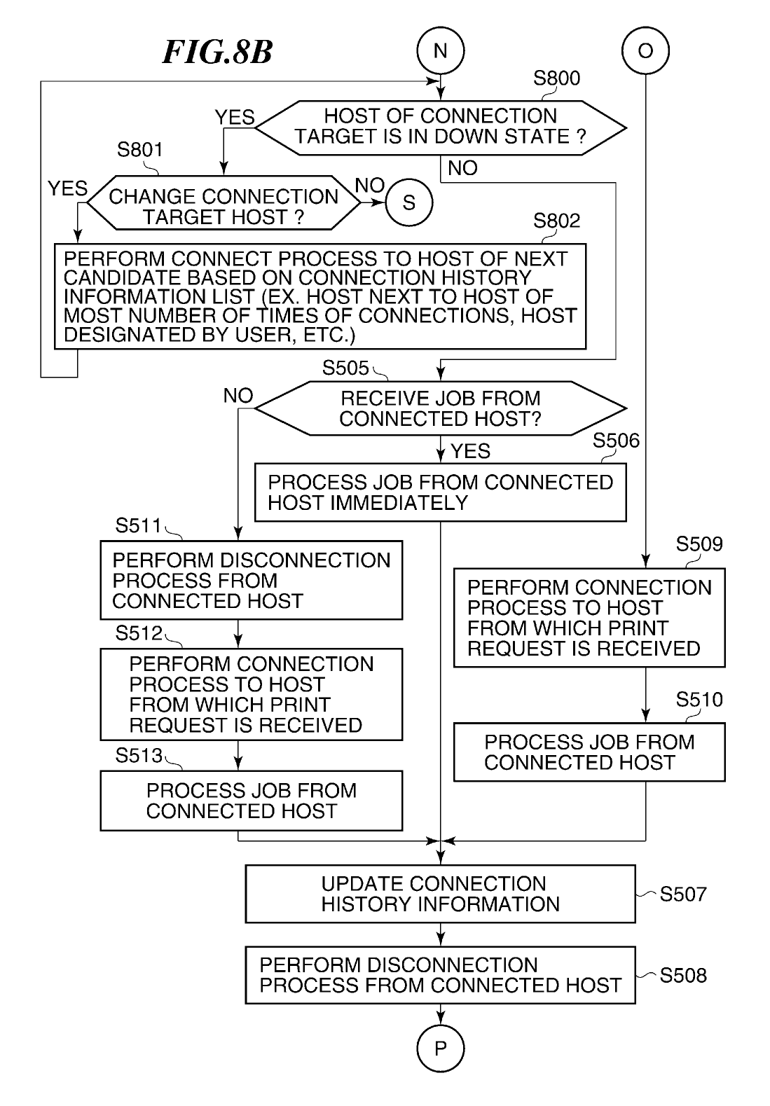

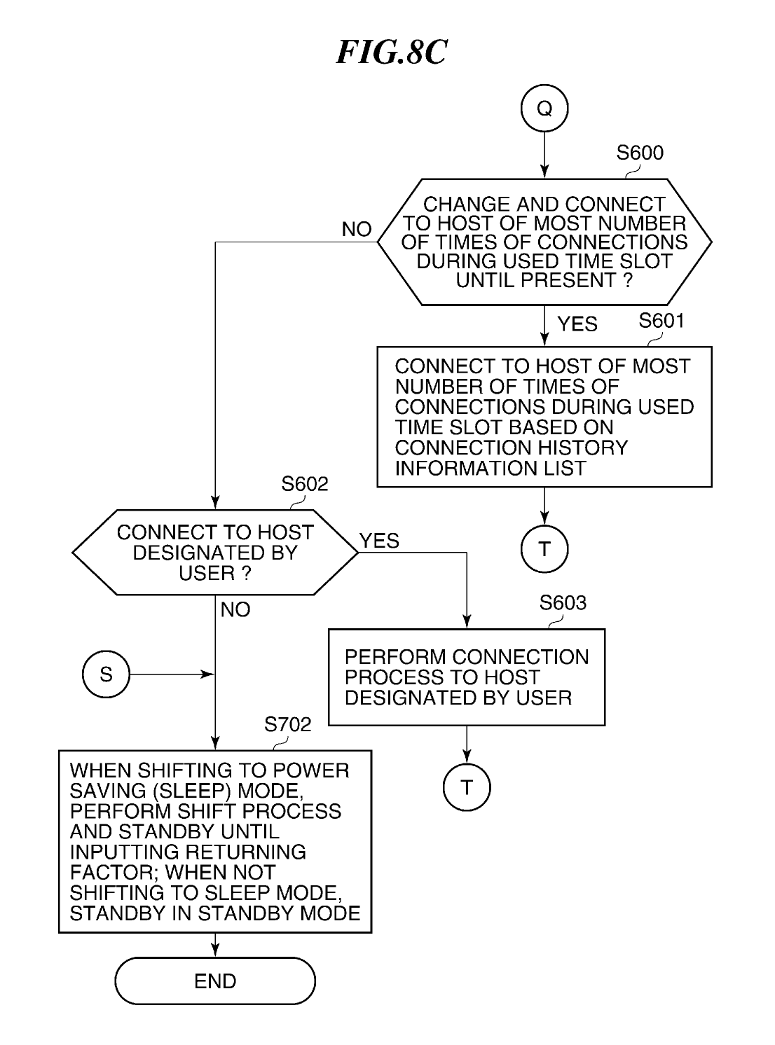

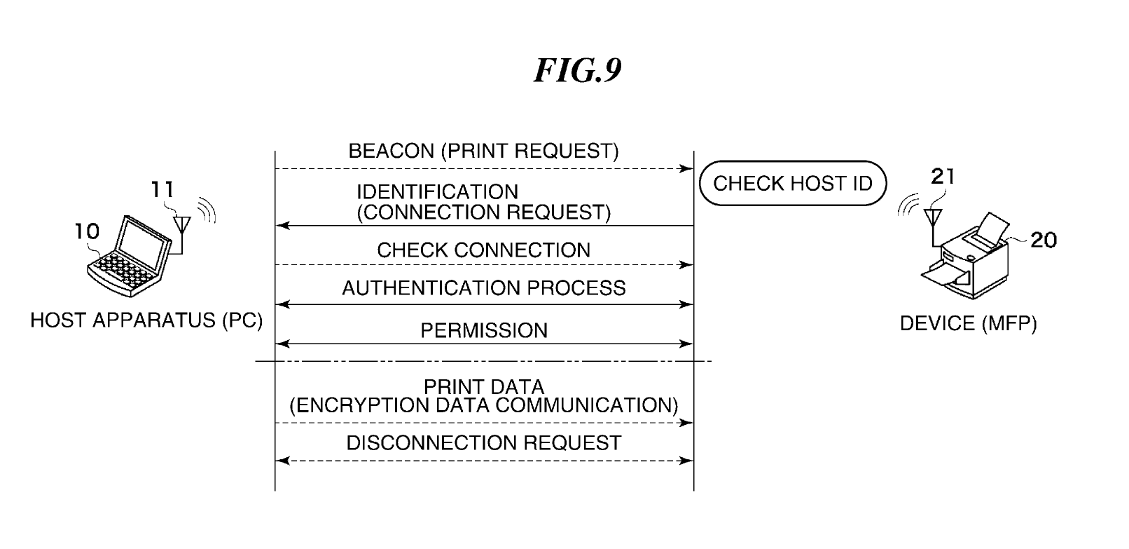

FIG. 4 is a view showing one example of listed connection history information stored into a host list storage unit of the image processing apparatus shown in FIG. 3.

FIGS. 5A and 5B are flowcharts showing a connection process between the image processing apparatus and the host PC.

FIGS. 6A to 6C are flowcharts showing a connection process to a host PC in an image processing apparatus according to a second embodiment of the present invention.

FIGS. 7A to 7C are flowcharts showing a connection process to a host PC in an image processing apparatus according to a third embodiment of the present invention.

FIGS. 8A to 8C are flowcharts showing a connection process to a host PC in an image processing apparatus according to a fourth embodiment of the present invention.

FIG. 9 is a view schematically showing connection establishment procedures by the WUSB communication.

### DESCRIPTION OF THE EMBODIMENTS

Hereafter, embodiments according to the present invention will be described in detail with reference to the drawings.

FIG. 1 is a view showing a schematic configuration of a system in which an image processing apparatus according to a first embodiment of the present invention is connected to a plurality of host PCs by WUSB communication.

As shown in FIG. 1, the image processing apparatus (MFP) 20 of this embodiment is connected to a plurality of host PCs 10a through 10c (three sets in FIG. 1) by the WUSB communication.

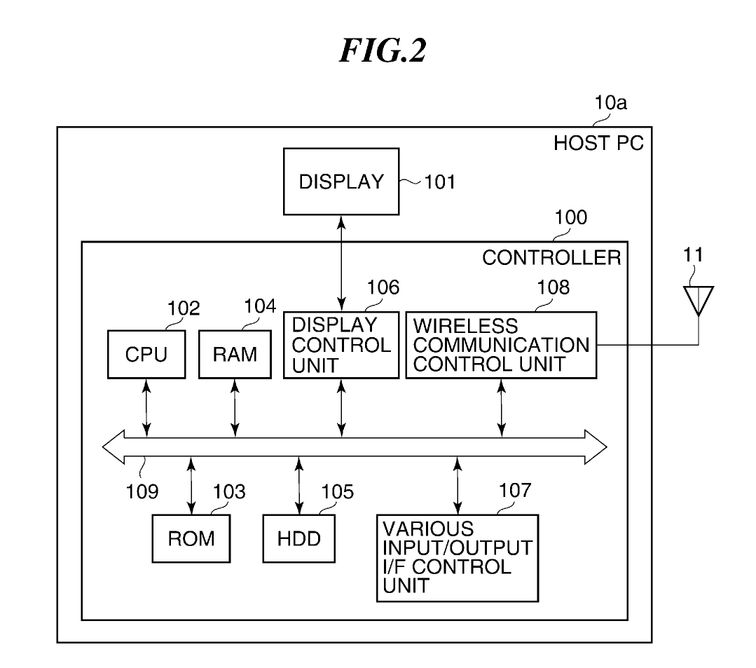

First, a configuration example of the host PC10a will be described with reference to FIG. 2. It should be noted that configuration examples of the host PCs 10b and 10c are not described because of the same configuration of the host PC 10a.

As shown in FIG. 2, the host PC 10a is equipped with a controller 100, a display 101, and a WUSB host antenna 11.

The controller 100 is provided with a CPU 102, a ROM 103, a RAM 104, a HDD 105, a display control unit 106, a various input/output I/F control unit 107, and a wireless communication control unit 108. The units 102 through 108 are connected via a system bus 109.

The CPU 102 has control over various processes executed by the controller 100. The ROM 103 is a boot ROM that stores a boot-up program of the system. The RAM 104 is a main memory of the CPU 102 and functions as a work memory for operating the system, an image memory for storing image data such as print data temporarily, etc. The RAM 104 is constituted so that memory capacity can be extended by an option RAM connected to an add-on port (not shown).

The HDD 105 stores system software and image data. The display control unit 106 controls an output of image data displayed on the display 101. The various input/output I/F control unit 107 is a control section for external interfaces to devices such as a keyboard and a mouse (not shown). Interfaces to a wired USB, a LAN, and the like can be provided as the external interfaces in addition to the interfaces to the devices such as a keyboard. The controller 100 can be connected to the communication networks through such external interfaces.

The wireless communication control unit 108 controls a WUSB via the WUSB host antenna 11, when there is a device that performs the WUSB communication around the host PC 10.

FIG. 3 is a block diagram schematically showing a configuration of the image processing apparatus according to the first embodiment of the present invention.

As shown in FIG. 3, the image processing apparatus 20 of this embodiment is equipped with a controller 200, a printer engine 201, an operation unit 202, and a WUSB device antenna 21.

The controller 200 is provided with a CPU 203, a ROM 204, a RAM 205, a printer I/F 206, an operation I/F 207, a wireless communication control unit 208, a host list storage unit 209, and a host list control unit 210. These units 203 through 210 are connected via a system bus 211.

The CPU 203 has control over access to each unit according to a control program stored in the ROM 204. The CPU 203 outputs image signals as output data to the printer engine 201 connected via the printer I/F 206.

The RAM 205 is a main memory of the CPU 203 and functions as a work area etc. The memory capacity can be extended by connecting an option RAM to an add-on port (not shown). It should be noted that the RAM 205 is used as an output information development area, an environment data storing area, etc.

The operation unit 202 in which an operation switch, a LED indicator, etc. are arranged is connected to the operation I/F 207. It should be noted that mode setting information etc. inputted from the operation unit 202 may be stored into a NVRAM (not shown).

The wireless communication control unit 208 controls a WUSB via the WUSB device antenna 21, when there is a host PC that performs the WUSB communication around the image processing apparatus 20.

The host list storage unit 209 stores a host ID etc. as a list. A beacon transmitted from one of the host PCs 10a through 10c via the WUSB host antenna 11 is received by the wireless communication control unit 208 via the WUSB device antenna 21. When receiving a print request from the host PC, the CPU 203 registers a host ID included in the beacon received, a number of times of connections, and a connected time into the host list storage unit 209, and lists them as connection history information.

The host list control unit 210 identifies the host ID list stored in the host list storage unit 209, and updates the connection history information stored in the host list storage unit 209 each time when a job process is finished.

FIG. 4 is a view showing one example of the listed connection history information stored into the host list storage unit 209 of the image processing apparatus shown in FIG. 3.

FIG. 4 shows the example in which the number of times of connections and the connected time are listed as a history per day. It should be noted that a unit to list as a history may by month etc. instead of day.

The host list control unit 210 determines whether or not a fixed time has passed under a condition where the image processing apparatus 20 is connected to none of the connectable host PCs, based on the connection history information stored in the host list storage unit 209 and conditions that have been set up separately. When it is determined that the fixed time has passed under the condition to be connected to none of the host PCs, the controller 200 controls so as to connect to the host PC that has the many number of times of connections and the high communication frequency. The host list control unit 210 updates the listed connection history information stored in the host list storage unit 209 each time when the job process is finished.

Next, a connection process between the image processing apparatus 20 and the host PC will be described with reference to FIGS. 5A and 5B. Each process in FIGS. 5A and 5B is achieved by loading a control program stored in the ROM 204 of the image processing apparatus 20 onto the RAM 205 and by executing the program by the CPU 203.

In step S500 in FIG. 5A, when receiving a print request transmitted from one of the host PCs 10a through 10c in FIG. 4 via the WUSB, the CPU 203 executes a printout process and proceeds with the process to step S501.

In step S501, the CPU 203 generates the connection history information list based on the information such as a host ID of the connected host PC, a connection date and time, etc., stores it into the host list storage unit 209, and proceeds with the process to step S502.

In the step S502, the CPU 203 determines whether or not the fixed time has passed under the condition where the image processing apparatus 20 does not receive a print request from any of the host PCs 10a through 10c and does not connect to any host PCs. And when the fixed time has passed under the condition, the CPU 203 proceeds with the process to step S503. When receiving the connection request from the host PC before the fixed time has passed, the process proceeds to step S509.

In the step S503, the CPU 203 determines whether or not to connect to the host PC to which the image apparatus 20 has been connected the most until present. In a case to connect, the process proceeds to step S504. In a case not to connect, the process proceeds to step S514, the system moves to a normal standby mode and finishes the process. It should be noted that the determination in the step S503 is made based on the information set up beforehand. That is, the image processing apparatus 20 can set whether or not to connect to the host PC to which the image apparatus 20 has been connected the most when the fixed time has passed under the condition where the image processing apparatus 20 does not connect to any host PCs, in advance, based on an instruction from a user.

In the step S504, the CPU 203 makes the host list control unit 210 select the host PC the host PC to which the image apparatus 20 has been connected the most based on the connection history information list stored in the host list storage unit 209 in the step S501, performs the connection process by the WUSB, and proceeds with the process to step S505. It should be noted that the host list control unit 210 selects the host PC 10a as the host PC the host PC to which the image apparatus 20 has been connected the most, and performs the connection process by the WUSB.

In the step S505, the CPU 203 determines whether or not the print request is received from the host PC 10a connected in the step S504. When the print request is received from the host PC 10a, the process proceeds to step S506. If not, the process proceeds to step S511.

In the step S506, since the CPU 203 has completed the connection process, the CPU 203 processes a print job immediately and proceeds with the process to step S507.

In the step S507, the CPU 203 updates the above-mentioned connection history information (the number of times of connections etc.) after the printout process, stores the updated information into the host list storage unit 209, and proceeds with the process to step S508.

In the step S508, the CPU 203 performs a disconnection process of the WUSB connection from the connected host PC 10a, terminates the connection, and returns the process to the step S502.

In the step S509, the CPU 203 performs a connection process with the host PC from which the print request is received, and proceeds with the process to step S510.

In the step S510, the CPU 203 processes the print job from the connected host PC, and proceeds with the process to the step S507.

In the step S507, the CPU 203 updates the above-mentioned connection history information (the number of times of connections etc.) after the printout process, stores the updated information into the host list storage unit 209, and proceeds with the process to the step S508.

In the step S508, the CPU 203 performs the disconnection process of the WUSB connection from the connected host PC, terminates the connection, and returns the process to the step S502.

In the step S511, the CPU 203 performs the disconnection process from the connected host PC 10a, and proceeds with the process to step S512.

In the step S512, the CPU 203 performs a connection process with the host PC 10b or 10c from which the print request is received by the WUSB, and proceeds with the process to step S513.

In the step S513, the CPU 203 processes the print job from the connected host PC, and proceeds with the process to the step S507.

In the step S507, the CPU 203 updates the above-mentioned connection history information (the number of times of connections etc.) after the printout process, stores the updated information into the host list storage unit 209, and proceeds with the process to the step S508.

In the step S508, the CPU 203 performs the disconnection process of the WUSB connection from the connected host PC, terminates the connection, and returns the process to the step S502.

As described above, in this embodiment, the image processing apparatus 20 is connected to the host PC 10a of the most number of times of connections when the fixed time has passed under the condition where the image processing apparatus does not communicate with any host PCs, in the environment where the image processing apparatus 20 and the host PCs 10a through 10c communicate by the WUSB.

Accordingly, since the host PC 10a has been already connected to the image processing apparatus 20 when the host PC 10a attempts to communicate with the image processing apparatus 20, the time required for the connection can be reduced, which enables to execute a process efficiently by the image processing apparatus 20.

Next, an image processing apparatus according to a second embodiment of the present invention will be described with reference to FIGS. 6A to 6C. It should be noted that duplicated sections or corresponding section with respect to the above-mentioned first embodiment will be described by diverting the figures and the signs.

In this embodiment, as shown in FIG. 6C, a process in steps S600 through S603 is added to the above-mentioned first embodiment (FIGS. 5A and 5B). The added process is executed when it is determined that the image processing apparatus does not connect to the host PC to which the image apparatus 20 has been connected the most until present in the step S503.

In the step S600, the CPU 203 determines whether or not to change and connect to the host PC to which the image apparatus 20 has been connected the most during a used time slot until present. In a case to connect, the process proceeds to the step S601. In a case not to connect, the process proceeds to the step S602. It should be noted that the determination in the step S600 is made based on the information set up beforehand. That is, the image processing apparatus 20 can set whether or not to connect to the host PC to which the image apparatus 20 has been connected the most during the used time slot when the fixed time has passed under the condition where the image processing apparatus 20 does not connect to any host PCs, in advance, based on an instruction from the user.

In the step S601, the CPU 203 makes the host list control unit 210 select the host PC to which the image apparatus 20 has been connected the most during the used time slot based on the connection history information list stored in the host list storage unit 209 in the step S501, performs the connection process by the WUSB, and proceeds with the process to step S505.

In the step S602, the CPU 203 determines whether or not a host PC to be connected has been designated by the user using the operation unit 202. When a host PC to be connected is designated, the CPU 203 performs the connection process to the host PC designated by the WUSB in the step S603, and proceeds with the process to the step S505. When a host PC to be connected is not designated, the CPU 203 proceeds with the process to the step S514. The other configurations and operation effects are the same as that of the above-mentioned first embodiment.

According to the second embodiment described above, the selection method to select a host PC to be connected when the fixed time has passed under the condition where the image processing apparatus is not connected to any host PCs can be set. That is, if needed, the image processing apparatus 20 can select a host PC to be connected from among the host PC to which the image apparatus 20 has been connected the most, the host PC to which the image apparatus 20 has been connected the most during the used time slot, and the host PC that has been designated by the user beforehand.

Next, an image processing apparatus according to a third embodiment of the present invention will be described with reference to FIGS. 7A to 7C. It should be noted that duplicated sections or corresponding section with respect to the above-mentioned first and second embodiments will be described by diverting the figures and the reference numerals.

In this embodiment, as shown in FIG. 7A to 7C, steps S700 and S701 are added between the steps S502 and S503 of the second embodiment (FIGS. 6A to 6C), and the step S514 in FIG. 6C is changed to step S702.

In the step S502 in FIG. 7A, when the fixed time has passed under the condition where the image processing apparatus 20 does not receive a print request from any of the host PCs 10a through 10c and does not connect to any host PCs, the CPU 203 proceeds with the process to the step S700.

In the step S700, the CPU 203 determines whether or not to shift to a power saving mode. When shifting to the power saving mode, the process proceeds to the step S701. When not shifting to the power saving mode, the process proceeds to the step S503.

In the step S701, the CPU 203 activates only the wireless communication control unit 208 etc. that are necessary for the WUSB connection, shuts off power supply to the printer engine etc., and proceeds with the process to the step S503.

In the step S602, when a host PC to be connected has not been designated by the user using the operation unit 202, the CPU 203 proceeds with the process to step S702.

In the step S702, when shifting to the power saving mode, the CPU 203 performs a shift process so as to activate only the units required to returning including the wireless communication control unit 208, and then, shifts to standby condition until inputting a returning factor. When not shifting to the power saving mode, the CPU 203 shifts to the normal standby mode and finishes the process. The other configurations and operation effects are the same as that of the above-mentioned first and second embodiments.

According to the third embodiment described above, the image processing apparatus can perform the connection process to the host PC of high use frequency when the fixed time has pass under the condition where the image processing apparatus does not connect to any host PCs, even if shifting to the power saving mode.

Next, an image processing apparatus according to a fourth embodiment of the present invention will be described with reference to FIGS. 8A to 8C. It should be noted that duplicated sections or corresponding section with respect to the above-mentioned first, second, and third embodiments will be described by diverting the figures and the reference numerals.

In this embodiment, as shown in FIG. 8B, steps S800 through S802 are added between the steps S504, S601, and S602 and the step S505 of the third embodiment (FIGS. 7A to 7C).

In the step S800, the CPU 203 determines whether or not the host PC is in a not-connectable state (a down state) when performing the WUSB connection process to the host PC that is selected or designated in the step S504, S601, or S602. When determining that the host PC is in the not-connectable state, the CPU 203 proceeds with the process to the step S801. If not, the process proceeds to the step S505.

In the step S801, the CPU 203 determines whether or not the host PC of a connection target is changed to another host apparatus. If the target is not changed, the process proceeds to the step S702. If the target is changed, the process proceeds to the step S-802. It should be noted that the determination in the step S801 is made based on the information set up beforehand. That is, the image processing apparatus 20 can set whether or not to connect to another host PC when the host PC is in the down state, when performing the connection process to the selected or designated host PC, in advance based on an instruction from the user.

In the step S802, the CPU 203 makes the host list control unit 210 select the host PC next to the host PC to which the image apparatus 20 has been connected the most or select the host PC that is designated by the user using the operation unit 202, based on the connection history information list mentioned above. Then, the CPU 203 performs the connection process with the selected host PC, and returns the process to the step S800. The other configurations and operation effects are the same as that of the above-mentioned first, second, and third embodiments.

According to the fourth embodiment described above, the image processing apparatus can perform the connection process to another host PC (a host PC next to the host PC of the highest use frequency) when performing the connection process to the host PC of the highest use frequency when the host PC concerned is in the down state.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-040886, filed on Feb. 24, 2009, which is hereby incorporated by reference herein in its entirety.

What is claimed is:

1. An image processing apparatus that is connected to a plurality of host apparatuses by wireless communication, comprising:
a generation unit adapted to generate connection history information based on information received from the host apparatuses;
a detection unit adapted to detect a condition in which none of the plurality of host apparatuses is connected; and
a control unit adapted to select a host apparatus of the highest communication frequency among the plurality of host apparatuses based on the connection history information when said detection unit detects the condition in which none of the plurality of host apparatuses is connected, and to perform a connection process to the selected host apparatus.

2. The image processing apparatus according to claim 1, wherein said control unit selects a host apparatus of the most number of times of connections to the image processing apparatus from among the plurality of host apparatuses.

3. The image processing apparatus according to claim 1, wherein said control unit selects a host apparatus of the most number of times of connections during a used time slot to the image processing apparatus among the plurality of host apparatuses.

4. The image processing apparatus according to claim 1, wherein said control unit performs the connection process to another host apparatus different from the selected host apparatus when performing the connection process to the selected host apparatus and when the selected host apparatus is in a not-connectable state.

5. The image processing apparatus according to claim 1, wherein said control unit terminates a connection to the selected host apparatus when receiving a connection request from another host apparatus during the connection to the selected host apparatus, and performs the connection process to the host apparatus from which the connection request is received.

6. The image processing apparatus according to claim 1, further comprising a designation unit adapted to designate a host apparatus to be connected among the plurality of host apparatuses by an operation of a user, and
wherein said control unit performs the connection process to the host apparatus designated by said designation unit, when said detection unit detects the condition in which none of the plurality of host apparatuses is connected and the host apparatus to be connected is designated by said designation unit.

7. A control method for an image processing apparatus that is connected to a plurality of host apparatuses by wireless communication, the control method comprising:
a generation step of generating connection history information based on information received from the host apparatuses;
a detection step of detecting a condition in which none of the plurality of host apparatuses is connected; and
a control step of selecting a host apparatus of the highest communication frequency among the plurality of host apparatuses based on the connection history information when the condition in which none of the plurality of host apparatuses is connected is detected in said detection step, and of performing a connection process to the selected host apparatus.

8. A storage medium storing a control program causing a computer to execute a control method for an image processing apparatus that is connected to a plurality of host apparatuses by wireless communication, the control method comprising:
a generation step of generating connection history information based on information received from the host apparatuses;
a detection step of detecting a condition in which none of the plurality of host apparatuses is connected; and
a control step of selecting a host apparatus of the highest communication frequency among the plurality of host apparatuses based on the connection history information when the condition to be condition in which none of the plurality of host apparatuses is connected is detected in said detection step, and of performing a connection process to the selected host apparatus.
